(19) United States
(12) Patent Application Publication
(10) Pub. No.: US 2025/0368386 A1
(43) Pub. Date: Dec. 4, 2025

(54) Tray With Article Retention Features

(71) Applicant: Graphic Packaging International, LLC, Atlanta, GA (US)

(72) Inventor: Karen L. Mills, Atlanta, GA (US)

(21) Appl. No.: 19/218,827

(22) Filed: May 27, 2025

Related U.S. Application Data
(60) Provisional application No. 63/652,397, filed on May 28, 2024.

(51) Int. Cl. B65D 5/50; B31B 50/26; B65D 5/28

(52) U.S. Cl. CPC B65D 5/5021; B31B 50/26; B65D 5/28

(57) ABSTRACT

A tray for holding a plurality of articles includes a plurality of panels extending at least partially around an interior of the tray, the plurality of panels including at least one bottom panel, at least one side panel, and at least one retainer panel, a plurality of end flaps foldably connected to a respective panel of the plurality of panels, and a plurality of article retention features at least partially defined in the at least one retainer panel, the article retention features for at least partially receiving and at least partially engaging the plurality of articles to maintain a position of the plurality of articles in the interior of the tray.

### CROSS-REFERENCE TO RELATED APPLICATION

The present application claims priority to U.S. Provisional Patent Application No. 63/652,397, filed on May 28, 2024.

### INCORPORATION BY REFERENCE

The disclosure of U.S. Provisional Patent Application No. 63/652,397, filed on May 28, 2024, is hereby incorporated by reference for all purposes as if set forth in its entirety.

### BACKGROUND OF THE DISCLOSURE

The present disclosure generally relates to containers for holding at least one article. In one embodiment, the present disclosure relates to containers in the form of trays for holding at least one article and that include article retention features.

### SUMMARY OF THE DISCLOSURE

According to one aspect, the disclosure is generally directed to a tray for holding a plurality of articles comprises a plurality of panels extending at least partially around an interior of the tray, the plurality of panels comprising at least one bottom panel, at least one side panel, and at least one retainer panel, a plurality of end flaps foldably connected to a respective panel of the plurality of panels, and a plurality of article retention features at least partially defined in the at least one retainer panel, the article retention features for at least partially receiving and at least partially engaging the plurality of articles to maintain a position of the plurality of articles in the interior of the tray.

According to another aspect, the disclosure is generally directed to a blank for forming a tray for holding a plurality of articles, the blank comprising a plurality of panels for extending at least partially around an interior of the tray formed from the blank, the plurality of panels comprising at least one bottom panel, at least one side panel, and at least one retainer panel, a plurality of end flaps foldably connected to a respective panel of the plurality of panels, and a plurality of article retention features at least partially defined in the at least one retainer panel, the article retention features for at least partially receiving and at least partially engaging the plurality of articles to maintain a position of the plurality of articles in the interior of the tray formed from the blank.

According to another aspect, the disclosure is generally directed to a method of forming a tray for holding a plurality of articles, the method comprising obtaining a blank, the blank comprising a plurality of panels comprising at least one bottom panel, at least one side panel, and at least one retainer panel, a plurality of end flaps foldably connected to a respective panel of the plurality of panels, and a plurality of article retention features at least partially defined in the at least one retainer panel. The method further comprises positioning the plurality of panels extending at least partially around an interior of the tray formed from the blank, and positioning the article retention features for at least partially receiving and at least partially engaging the plurality of articles to maintain a position of the plurality of articles in the interior of the tray.

Those skilled in the art will appreciate the above stated advantages and other advantages and benefits of various additional embodiments reading the following detailed description of the embodiments with reference to the below-listed drawing figures. It is within the scope of the present disclosure that the above-discussed aspects be provided both individually and in various combinations.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of an exterior surface of a blank for forming a tray according to a first exemplary embodiment of the disclosure.

FIG. 1A is an enlarged view of a portion of the blank of FIG. 1.

FIG. 1B is an enlarged view of another portion of the blank of FIG. 1.

FIG. 2 is a perspective view of a tray formed from the blank of FIG. 1 according to the first exemplary embodiment of the disclosure and with articles retained therein.

FIG. 3 is another perspective view of the tray of FIG. 2 without articles.

FIG. 4 is a plan view of an exterior surface of a blank for forming a tray according to a second exemplary embodiment of the disclosure.

FIG. 5 is a perspective view of a tray formed from the blank of FIG. 4 according to the second exemplary embodiment of the disclosure and with articles retained therein.

FIG. 6 is another perspective view of the tray of FIG. 5 without articles.

FIG. 7 is a plan view of an exterior surface of a blank for forming a tray according to a third exemplary embodiment of the disclosure.

FIG. 8 is a perspective view of a tray formed from the blank of FIG. 7 according to the third exemplary embodiment of the disclosure and with articles retained therein.

FIG. 9 is another perspective view of the tray of FIG. 8 without articles.

FIG. 10 is a plan view of an exterior surface of a blank for forming a tray according to a fourth exemplary embodiment of the disclosure.

FIG. 11 is a perspective view of a tray formed from the blank of FIG. 9 according to the fourth exemplary embodiment of the disclosure and with articles retained therein.

FIG. 12 is another perspective view of the tray of FIG. 11 without articles.

FIG. 13 is a plan view of an exterior surface of a blank for forming a tray according to a fifth exemplary embodiment of the disclosure.

FIG. 14 is a perspective view of a tray formed from the blank of FIG. 13 according to the fifth exemplary embodiment of the disclosure and with articles retained therein.

FIG. 15 is another perspective view of the tray of FIG. 14 without articles.

FIG. 16 is a plan view of an exterior surface of a blank for forming a tray according to a sixth exemplary embodiment of the disclosure.

FIG. 16A is an enlarged view of a portion of the blank of FIG. 16.

FIG. 17 is a perspective view of a tray formed from the blank of FIG. 16 according to the sixth exemplary embodiment of the disclosure and with articles retained therein.

FIG. 18 is another perspective view of the tray of FIG. 17 without articles.

Corresponding parts are designated by corresponding reference numbers throughout the drawings.

### DETAILED DESCRIPTION OF THE EXEMPLARY EMBODIMENTS

Containers such as trays according to the present disclosure can accommodate containers of numerous different shapes. In this specification, the terms “lower,” “bottom,” “upper,” “top,” “front,” and “back” indicate orientations determined in relation to fully erected trays. As described herein, containers may be formed by multiple overlapping panels, portions, and/or end flaps. Such panels, portions, and/or end flaps may be designated in relative terms to one another, e.g., “first”, “second”, “third”, etc., in sequential or non-sequential reference, without departing from the disclosure.

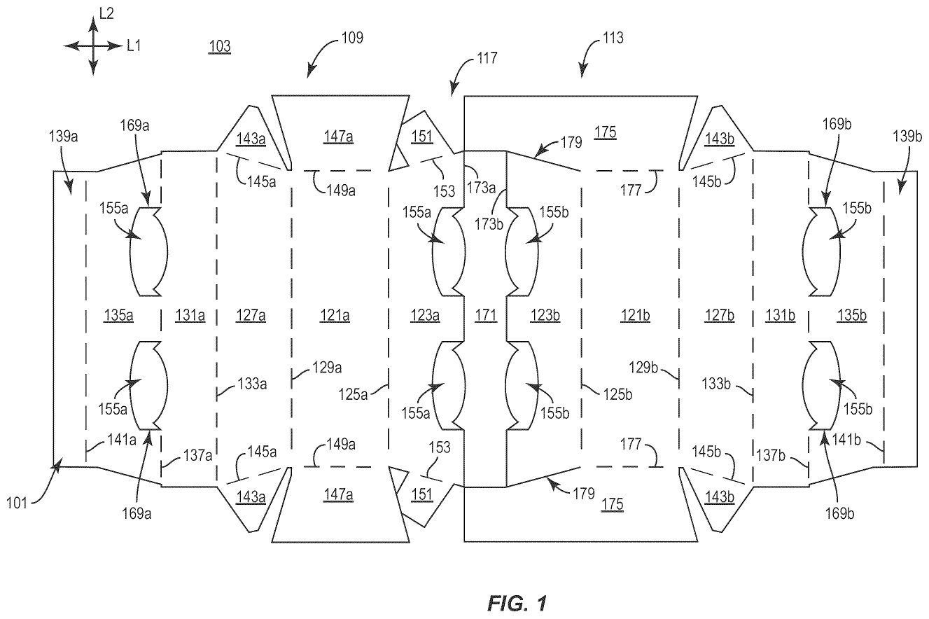

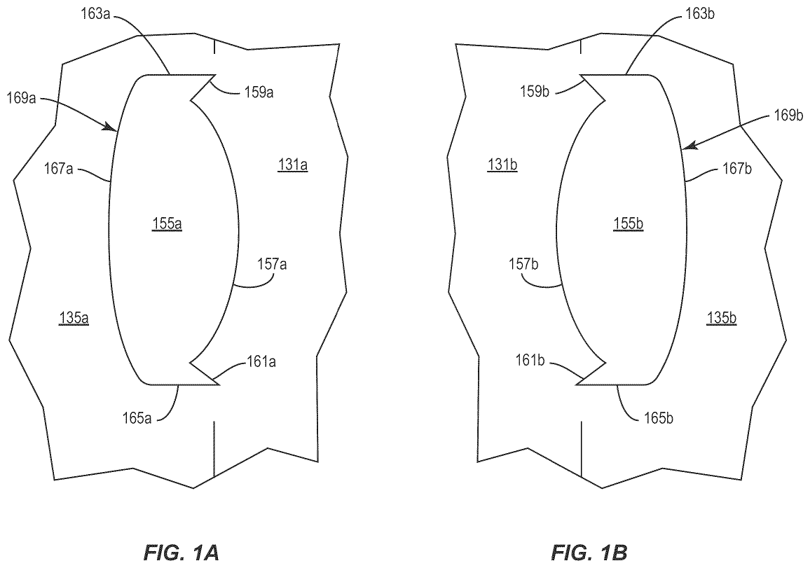

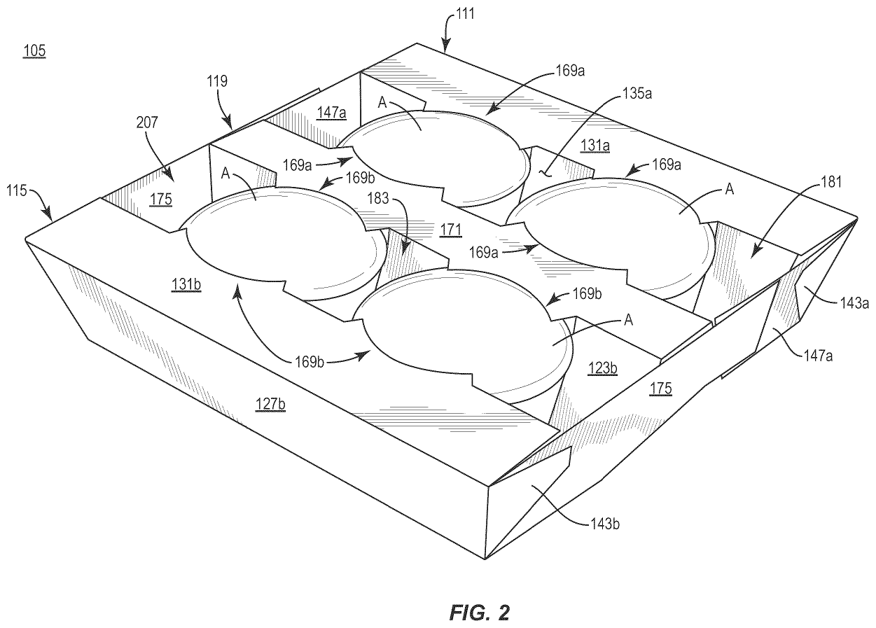

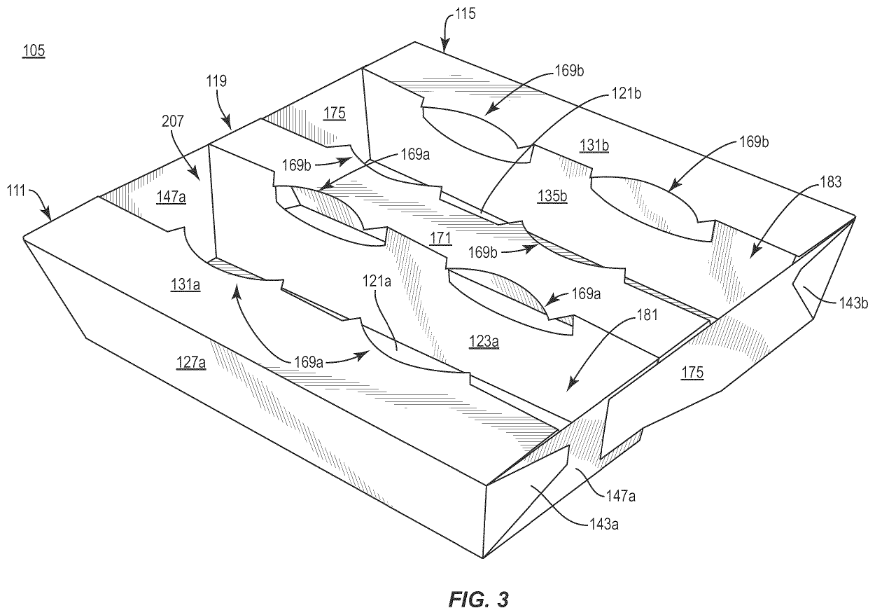

According to a first exemplary embodiment of the disclosure, FIG. 1 illustrates an exterior surface 101 of a tray blank 103 for forming a container in the form of a tray 105 (FIG. 2). It will be understood that the tray 105 can have a different configuration, for example, a bowl, dish, plate, box, or carton, to name a few.

As described herein, the tray 105 can have an interior 107 that can be used for holding one or more articles A (FIG. 2) such as food products, e.g., portioned retail food products that can include one or more of cookies, crackers, cakes, muffins, pastries, brownies, candies, nuts, popcorn, trail mix, gum, etc. In some embodiments, the articles can include frozen or non-frozen food products that can be provided in discrete portions, for example, chicken nuggets, French fries, onion rings, mozzarella sticks, chips, popcorn, other finger foods, etc. In some embodiments, other types of articles that can include food products and/or non-food products can be placed in the tray 105 for service to a customer. In some embodiments, such products can be contained in additional packaging and then placed in the tray 105. The tray 105 could be otherwise shaped and arranged and could be used to hold other products and/or articles in similar or different environments without departing from the disclosure.

As shown in FIG. 1, the blank 103 has a lateral axis L1 and a longitudinal axis L2. The blank 103 can have a front portion 109 for forming a front portion 111 of the tray 105 formed from the blank 103, a back portion 113 for forming a back portion 115 of the tray 105 formed from the blank 103, and a divider portion or central portion 117 for forming a divider portion or central portion 119 of the tray 105 formed from the blank 103.

The blank 103 can include a plurality of panels for at least partially extending around the interior 107 of the tray 105 formed from the blank 103. In the illustrated embodiment, the front panel 109 of the blank 103 can include a front bottom panel 121a, a front first inner side panel 123a foldably connected to the bottom panel 121a at a lateral fold line 125a, a front outer side panel 127a foldably connected to the bottom panel 121 a at a lateral fold line 129a, a front top panel or front retainer panel 131a foldably connected to the outer side panel 127a at a lateral fold line 133a, and a front second inner side panel 135a foldably connected to the retainer panel 131a at a lateral fold line 137a.

The blank 103 can also include a plurality of end flaps foldably connected to a respective panel of the plurality of panels. As shown, a front attachment end flap 139a can be foldably connected to the second inner side panel 135a at a lateral fold line 141a. A pair of front outer attachment end flaps 143a can be foldably connected to laterally opposed ends of the outer side panel 127a at respective oblique fold lines 145a, a pair of front central end flaps 147a can be foldably connected to laterally opposed ends of the bottom panel 127a at respective longitudinal fold lines 149a, and a pair of front inner attachment end flaps 151 can be foldably connected to laterally opposed ends of the first inner side panel 123a at respective oblique fold line 153. In some embodiments, the front inner attachment end flaps 151 can be at least partially separable from the respective front central end flaps 147a at a respective cut.

The blank 103 and tray 105 formed therefrom can also include article retention features 169a, 169b (FIG. 2) for at least partially retaining one or more articles in the interior 107 of the tray 105 formed from the blank 103.

With additional reference to FIG. 1A, a pair of article retention openings 155a can be at least partially defined in respective portions of the retainer panel 131a and the second inner side panel 135a. As shown, the article retention openings 155a can at least partially interrupt the fold line 137a, and can be at least partially defined by a generally curved article retention edge 157a formed in respective portions of the panels 131a, 135a, the article retention edge 157a intersecting endpoints of respective oblique article retention edges 159a, 161a extending to respective longitudinal edges 163a, 165a that intersect respective endpoints of a curved edge 167a.

As described further herein, the respective edges 157a, 159a, 161a can at least partially form respective article retention features 169a protruding from respective portions of the retainer panel 131a when the tray 105 is formed from the blank 103. Furthermore, the article retention openings 155a can be configured and arranged for at least partially receiving an article therethrough when the tray 105 is formed from the blank 103. It will be understood that the article retention features 169a can include the article retention openings 155a.

As shown, the central portion 117 of the blank 103 can comprise a divider panel or central panel 171 foldably connected to the inner side panel 123a at a lateral fold line 173a, and a pair of laterally spaced article retention openings 155a and associated features can be positioned interrupting the lateral fold line 173a so as to be at least partially formed in each of the central panel 171 and the inner side panel 123a.

In this regard, and as described further herein, article retention features 169a can be at least partially defined extending from the central panel 171 toward the front portion 109 of the blank 103/front portion 111 of the tray 105, e.g., such that the respective edges 157a, 159a, 161a thereof can protrude from respective portions of the central panel 171 when the tray 105 is formed from the blank 103.

In the illustrated embodiment, the features of the back portion 113 of the blank 103 and the back portion 115 of the tray 105 formed therefrom can have features so as to be generally a mirror-image of the corresponding panels, flaps, and portions of the front portion 109 of the blank 103/front portion 111 of the tray 105. Corresponding components (e.g., panels, flaps, fold lines, cuts, etc.) have been designated by corresponding reference numbers that differ by the “a” or “b” suffix, with the “a” components corresponding to the front portion 109 of the blank 103/front portion 111 of the tray 105 and the “b” components corresponding to the back portion 113 of the blank 103/back portion 115 of the tray 105.

In this regard, the back portion 113 of the blank 103/back portion 115 of the tray 105 can include a back bottom panel 121b, a back first inner side panel 123b, a back outer side panel 127b, a back top panel or back retainer panel 131b, a back second inner side panel 135b, back end flaps 139b, 143b, article retention openings 155b, article retention features 169b, and associated features.

However, the back portion 113 of the blank 103/back portion 115 of the tray 105 can include a pair of back central end flaps 175 foldably connected to the back bottom panel 121b at respective opposite lateral ends thereof at respective longitudinal fold lines 177. The back central end flaps 175 can be separable from the central panel 171 and the back inner side panel 123b at respective cuts 179 that include a respective longitudinal segment between the respective portion of the end flap 175 and the central panel 171, and a respective oblique segment between the respective portion of the end flap 175 and the back bottom panel 121b.

Furthermore, and with additional reference to FIG. 1B, the back portion 113 of the blank 103/back portion 115 of the tray 105 can include container retention openings 155b and associated features that are generally a mirror-image of the container retention openings 155a described above taken over the lateral axis L2.

With additional reference to FIGS. 2 and 3, in some embodiments, the blank 103 can be positioned with the exterior surface 101 thereof on a supporting surface, e.g., a table, conveyor, bedplate, etc., and with an interior surface thereof (e.g., planarly opposite the exterior surface 101) facing upwardly.

The front side panels 123a, 127a can be folded at least partially upwardly relative to the front bottom panel 121a at the respective fold lines 125a, 129a into generally upright relation therewith.

The retainer panel 131a can be folded at the fold line 133a into generally spaced and planar relation with and above the bottom panel 121a, and the front inner side panel 135a can be folded at the fold line 137a to extend downwardly to the bottom panel 121a. The retainer panel 131a can thus extend from the outer side panel 127a to the front inner side panel 135a. The attachment end flap 139a can be folded at the fold line 141a into at least partial face-to-face contact with the bottom panel 121a.

Simultaneously or thereafter, the end flaps 147a can be at least partially folded at the respective fold lines 149a into generally upright relation with the bottom panel 121a and into generally abutting relation with the panels 123a, 127a, 131a, 135a. The respective end flaps 143a can be at least partially folded at the respective fold lines 145a into at least partial face-to-face contact with respective portions of the respective end flaps 147a, and the respective end flaps 151 can be at least partially folded at the respective fold lines 153a into at least partial face-to-face contact with respective portions of the respective end flaps 147a.

Similarly, the back side panels 123b, 127b can be folded at least partially upwardly relative to the back bottom panel 121b at the respective fold lines 125b, 129b into generally upright relation therewith, the retainer panel 131b can be folded at the fold line 133b into generally spaced and planar relation with and above the bottom panel 121b, and the back side panel 135b can be folded at the fold line 137b to extend downwardly to the bottom panel 121b. The attachment end flap 139b can be folded at the fold line 141b into at least partial face-to-face contact with the bottom panel 121b.

Simultaneously or thereafter, the end flaps 175 can be at least partially folded at the respective fold lines 177 into generally upright relation with the bottom panel 121b and into generally abutting relation with the panels 123b, 127b, 131b, 135b. Such movement of the end flaps 175 can cause at least partial separation thereof from respective portions of the back side panel 123b and the central panel 171 at respective portions of the respective cuts 179.

In such an arrangement, the respective end flap 175 can be positioned at least partially overlapping respective portions of the end flaps 151 and the end flaps 147a. In this regard, in some embodiments, the respective end flaps 151 can be positioned in at least partial face-to-face contact with each of the respective end flaps 147a, 175.

The aforementioned arrangement of the tray 105 provides the front portion 111 and the back portion 115 thereof at least partially separated by the central panel 171 extending therebetween, with the front portion 111 at least partially defining a front interior space 181 in the interior 107 of the tray 105 and with the back portion 115 at least partially defining a back interior space 183 in the interior 107 of the tray 105.

It will be understood that, prior to, during, and/or following formation of the tray 105 from the blank 103, one or more articles A can be at least partially received in the interior 107 of the tray 105.

In such arrangements, a respective article A, e.g., a food product such as a snack cake, cookie, mini brownie, etc., can be at least partially received in the respective interior space 181, 183 in the interior 107 of the tray 105 and can be at least partially received through a respective article retention opening 155a, 155b and at least partially overlapped by a respective article retention feature 169a, 169b.

For example, and as shown, one or more articles A can be at least partially received in the front interior space 181 of the tray 105 and at least partially received through a respective article retention opening 155a so as to be at least partially recessed in a space between respective portions of the bottom panel 121a, the outer side panel 127a, and the retainer panel 131a and so as to be at least partially recessed in a space between respective portions the front inner side panel 123a, the central panel 171, and the back inner side panel 123b.

Similarly, one or more articles A can be at least partially received in the back interior space 183 of the tray 105 and at least partially received through a respective article retention opening 155b so as to be at least partially recessed in a space between respective portions of the bottom panel 121b, the outer side panel 127b, and the retainer panel 131b and so as to be at least partially recessed in a space between respective portions the back inner side panel 123b, the central panel 171, and the front inner side panel 123a.

In some embodiments, the respective article A can be at least partially engaged by the respective article retention feature 169a, 169b, for example, via contact with a free edge and/or surface of the respective article retention feature 169a, 169b, e.g., respective edges 157a, 159a, 161a, 157b, 159b, 161b. In some embodiments, the respective article A can be at least partially compressed between the respective article retention feature 169a, 169b and the respective bottom panel 121a, 121b. In other embodiments, the engagement of the respective article A with the respective article retention features 169a, 169b can at least partially suspend the respective article A above the respective bottom panel 121a, 121b in the interior 107 of the tray 105. In other embodiments, the engagement of the respective article A with the respective article retention features 169a, 169b can at least partially suspend the respective article A above the respective bottom panel 121a, 121b in the interior 107 of the tray 105.

In this regard, the tray 105 is provided with article retention features for at least partially retaining respective articles A in the interior 107 thereof. Such retention of the article(s) A can advantageously maintain articles A during incidental movement, for example, during shipping, storage, placement in a retail location, transport from a retail location to a customer's home or other desired location, etc.

In some embodiments, the article retention features of the tray 105 can provide an at least partially recessed engagement of a respective article A, e.g., such that at least a portion of a respective article A is at least partially surrounded by respective panels, end flaps, and/or other features thereof, such that the respective article A is at least partially protected from an outside environment thereby, e.g., so as to avoid damaging contact, so as to transmit external forces away from the respective article A, etc. In some embodiments, the tray 105 can be provided with one or more articles A as a package.

It will be understood that the tray 105 can have a different configuration and/or arrangement without departing from the disclosure.

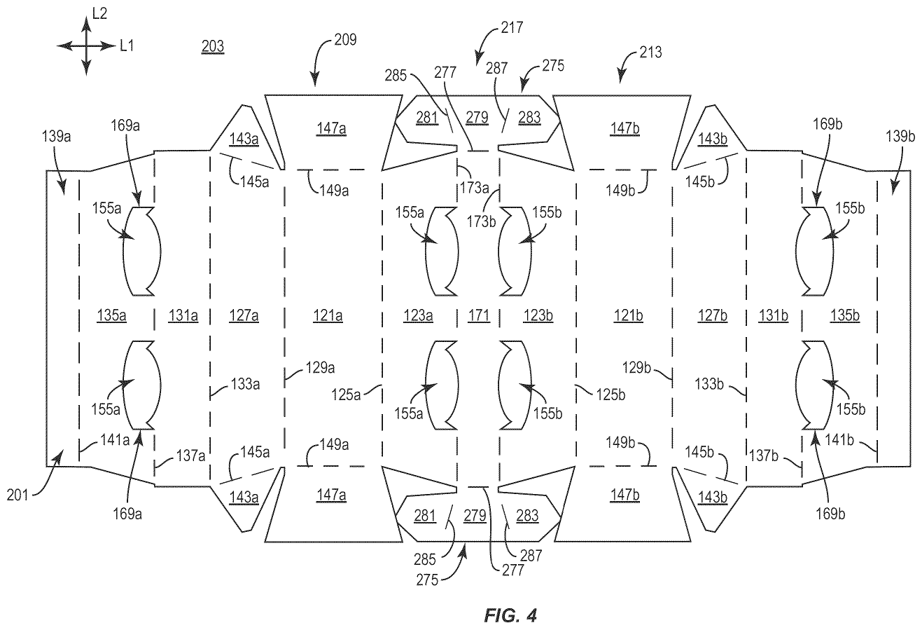

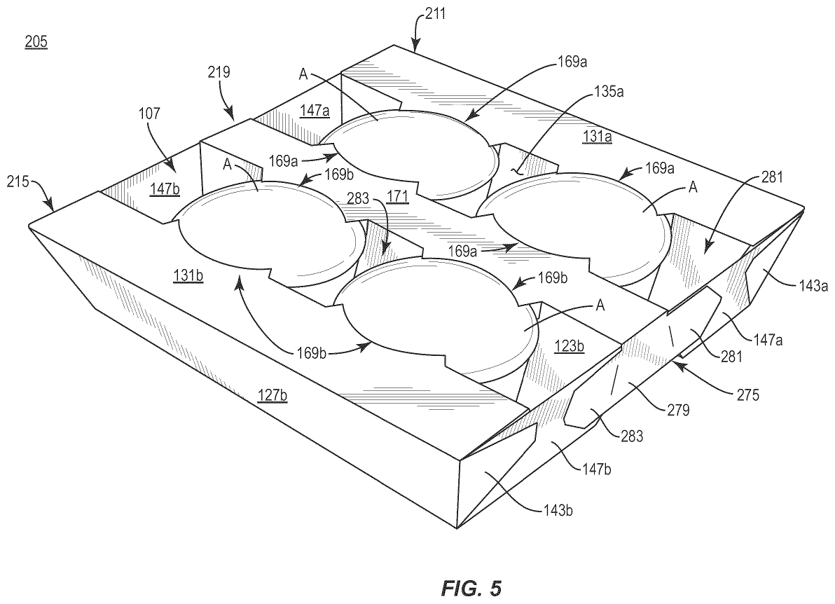

Turning to FIG. 4, the exterior surface 201 of a blank 203 for forming a container 205 (FIG. 5) according to a second exemplary embodiment of the disclosure is shown. The blank 203 and tray 205 formed therefrom can have one or more features that are the same or similar to those described above with respect to the blank 103 and tray 105 formed therefrom, and like or similar features are designated with like or similar reference numerals.

The blank 203 can have the longitudinal axis L1 and the lateral axis L2, and can include a front portion 209 for forming a front portion 211 of the tray 205 formed therefrom, a back portion 213 for forming a back portion 215 of the tray 205 formed therefrom, and a central portion 217 for forming a central portion 219 of the tray 205 formed therefrom that extends from the front portion 209/211 to the back portion 213/215.

The blank 203 and tray 205 formed therefrom can include the panels 121a, 121b, 123a, 123b, 127a, 127b, 131a, 131b, 135a, 135b, 171, end flaps 139a, 139b, 143a, 143b, 147a, article retention openings 155a, 155b, and article retention features 169a, 169b. The blank 203 and tray 205 formed therefrom can also include respective front central end flaps 147b foldably connected to the back bottom panel 121b at respective fold lines 149b, the end flaps 147b and fold lines 149b having a configuration generally similar to that of the end flaps 147a and fold lines 149a.

However, the blank 203 and tray 205 formed therefrom can include respective central end flaps 275 foldably connected to the central panel 171 at a respective longitudinal fold line 277. Each end flap 275, as shown, can include a respective central portion 279 and respective outer portions 281, 283 foldably connected to the respective central portion 279 at a respective oblique fold line 285, 287.

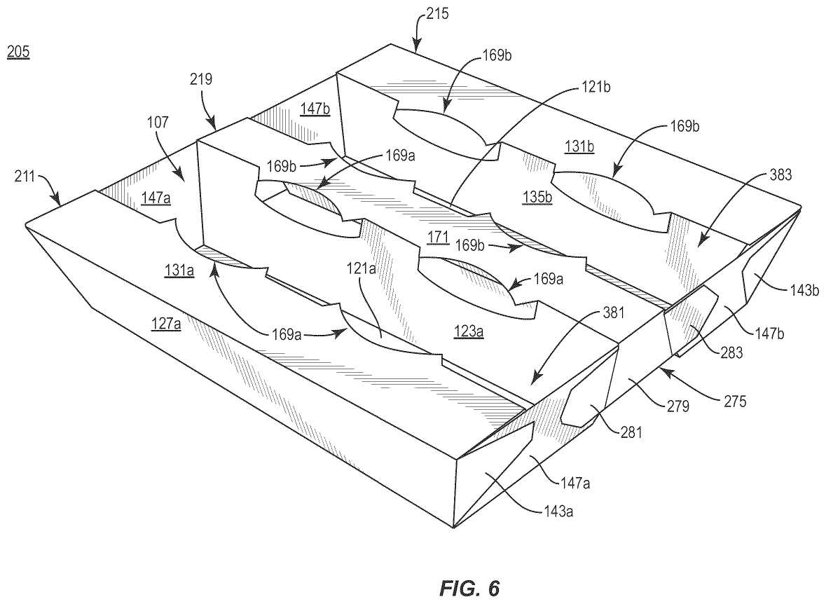

Turning to FIGS. 5 and 6, the tray 205 can be formed from the blank 203 in a manner generally similar to that described above with respect to the formation of the tray 105 from the blank 103, with similar advantages and functionality.

However, the end flaps 275 can be folded downwardly at the respective fold lines 277 such that the central portions 279 thereof are positioned generally aligned with the central panel 171, such that the outer portions 281 thereof are positioned for at least partial face-to-face contact with the respective end flaps 147a, and such that the outer portions 283 thereof are positioned for at least partial face-to-face contact with the respective end flaps 147b.

In some embodiments, one or both of the outer portions 281, 283 of the respective end flaps 275 can be at least partially folded at a respective fold lines 285, 287 to facilitate such arrangement of the end flap(s) 275. Such an arrangement can be at least partially maintained with one or more applications of an adhesive such as glue.

The aforementioned arrangement of the tray 205 provides the front portion 211 and the back portion 215 thereof at least partially separated by the central panel 171/central portion 219 extending therebetween, with the front portion 211 at least partially defining a front interior space 281 in the interior 207 of the tray 205 and with the back portion 215 at least partially defining a back interior space 283 in the interior 207 of the tray 105.

It will be understood that, prior to, during, and/or following formation of the tray 205 from the blank 203, one or more articles A can be at least partially received in the interior 207 of the tray 205. In some embodiments, one or more articles A can be at least partially received in the interior 207 of the tray 205 as a package.

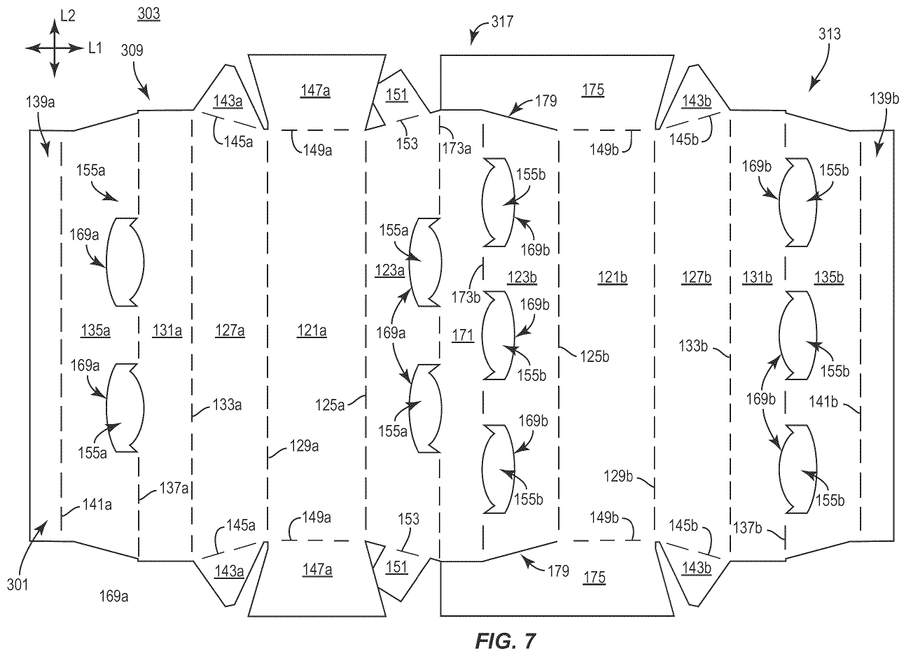

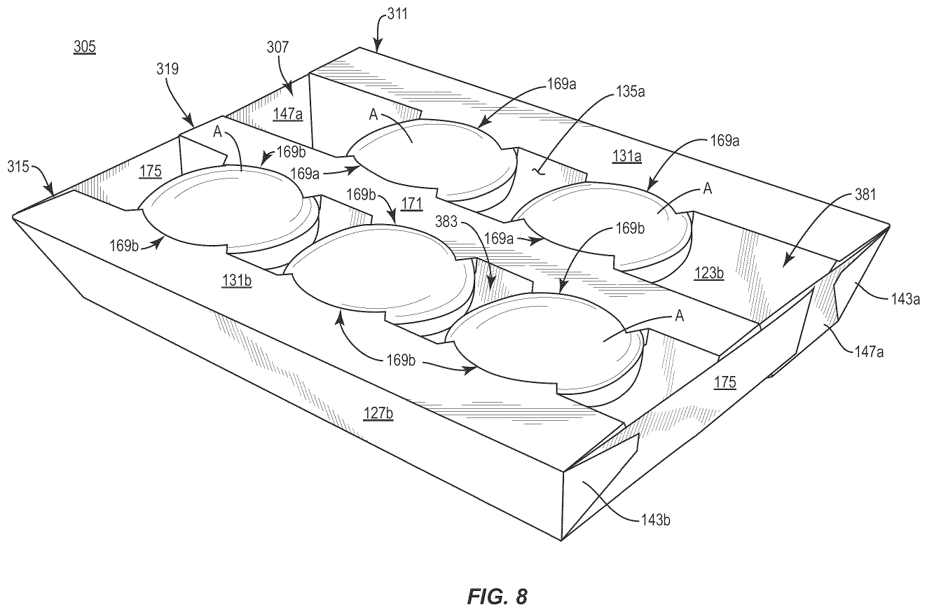

Turning to FIG. 7, the exterior surface 301 of a blank 303 for forming a tray 305 (FIG. 8) according to a third exemplary embodiment of the disclosure is shown. The blank 303 and tray 305 formed therefrom can have one or more features that are the same or similar to those described above with respect to the blanks 103, 203 and trays 105, 205 formed therefrom, and like or similar features are designated with like or similar reference numerals.

The blank 303 can have the longitudinal axis L1 and the lateral axis L2 and can include a front portion 309 for forming a front portion 311 of the tray 305 formed therefrom, a back portion 313 for forming a back portion 315 of the tray 305 formed therefrom, and a central portion 317 for forming a central portion 319 of the tray 305 formed therefrom that extends from the front portion 309/311 to the back portion 313/315.

The blank 303 and tray 305 formed therefrom can include the panels 121a, 121b, 123a, 123b, 127a, 127b, 131a, 131b, 135a, 135b, 171, end flaps 139a, 139b, 143a, 143b, 147a, 151, 175 article retention openings 155a, 155b, article retention features 169a, 169b, and associated features.

However, the blank 303 and tray 305 formed therefrom can have a generally longer dimension in the lateral direction L2 than the blanks 103, 203 and trays 105, 205 described above. As shown, the front portion 309/311 of the blank 303/tray 305 can have respective pairs of laterally-spaced article retention openings 155a and associated features, and the back portion 315/517 of the blank 303/tray 305 can have respective sets of three laterally-spaced article retention openings 155b and associated features, for example, for providing a selected arrangement of articles A in the tray 305. It will be understood that a different arrangement of article retention openings and features can be provided without departing from the disclosure.

In some embodiments, at least one of the end flaps 175 can include an oblique line of weakening, for example, to facilitate formation of the tray 305 from the blank 303.

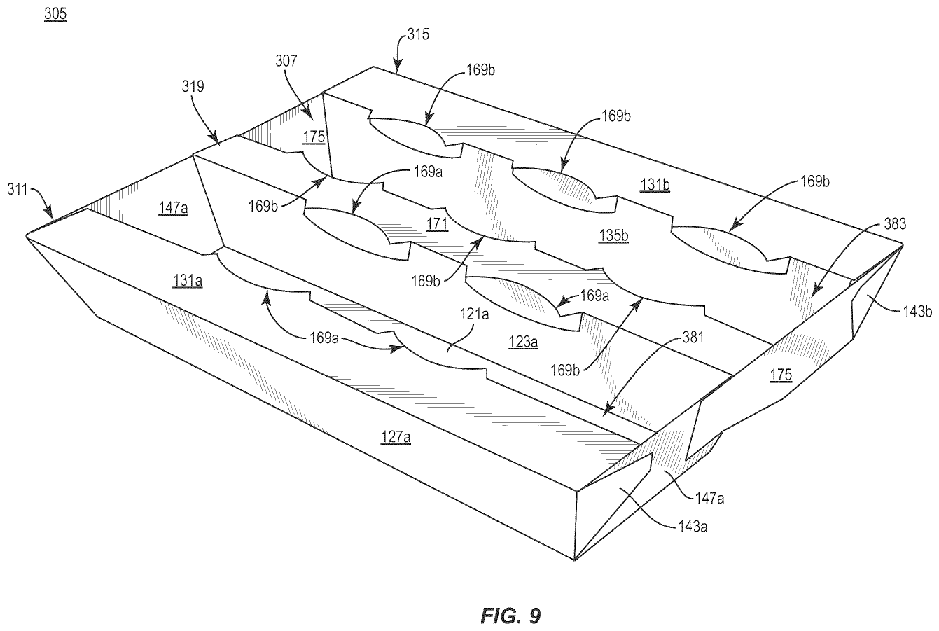

Turning to FIGS. 8 and 9, the tray 305 can be formed from the blank 303 in a manner generally similar to that described above with respect to the formation of the trays 105, 205 from the blanks 103, 203 with similar advantages and functionality.

The aforementioned arrangement of the tray 305 provides the front portion 311 and the back portion 315 thereof at least partially separated by the central panel 171/central portion 319 extending therebetween, with the front portion 311 at least partially defining a front interior space 381 in the interior 307 of the tray 305 and with the back portion 315 at least partially defining a back interior space 383 in the interior 307 of the tray 305.

It will be understood that, prior to, during, and/or following formation of the tray 305 from the blank 303, one or more articles A can be at least partially received in the interior 307 of the tray 305 for being at least partially engaged by the respective container retention features 169a, 169b. In some embodiments, the tray 305 can be provided with one or more of the articles A as a package.

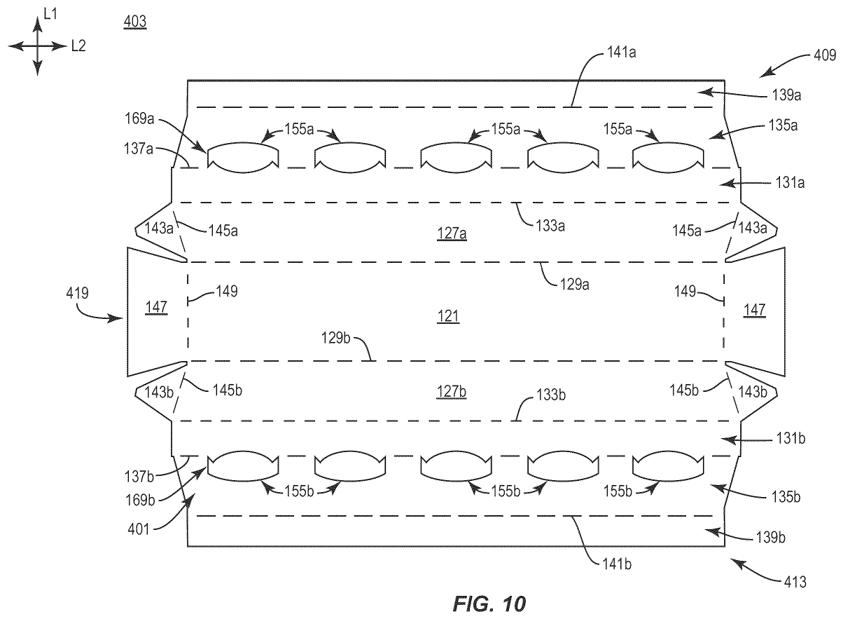

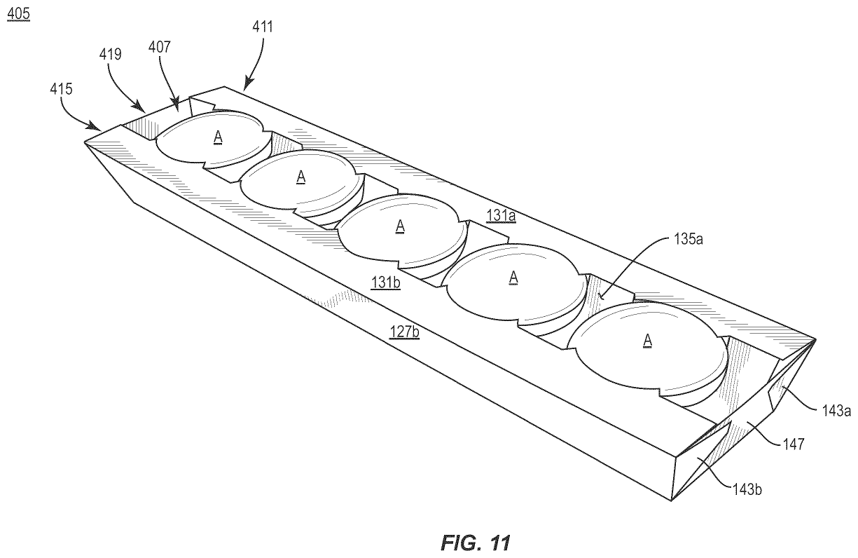

Turning to FIG. 10, the exterior surface 401 of a blank 403 for forming a tray 405 (FIG. 11) according to a fourth exemplary embodiment of the disclosure is shown.

The blank 403 can have the longitudinal axis L1 and the lateral axis L2 and can include a front portion 409 for forming a front portion 411 of the tray 405 formed therefrom, a back portion 413 for forming a back portion 415 of the tray 405 formed therefrom, and a central portion 417 for forming a central portion 419 of the tray 405 formed therefrom that extends from the front portion 409/411 to the back portion 413/415.

The blank 403 and tray 405 formed therefrom can include a bottom panel 121 generally similar to the panel 121a or 121b, the panels 127a, 127b, 131a, 131b, 135a, 135b, end flaps 139a, 139b, 143a, 143b, article retention openings 155a, 155b, article retention features 169a, 169b, and associated features. Respective central end flaps 147 (generally similar to the end flaps 147a or 147b) can be foldably connected to the bottom panel 121 at respective longitudinal fold lines 149.

The blank 403 and tray 405 formed therefrom can also be devoid of the central panel 171 such that at least a portion of the bottom panel 121 can form the central portion 417 of the blank 403/central portion 419 of the tray 405.

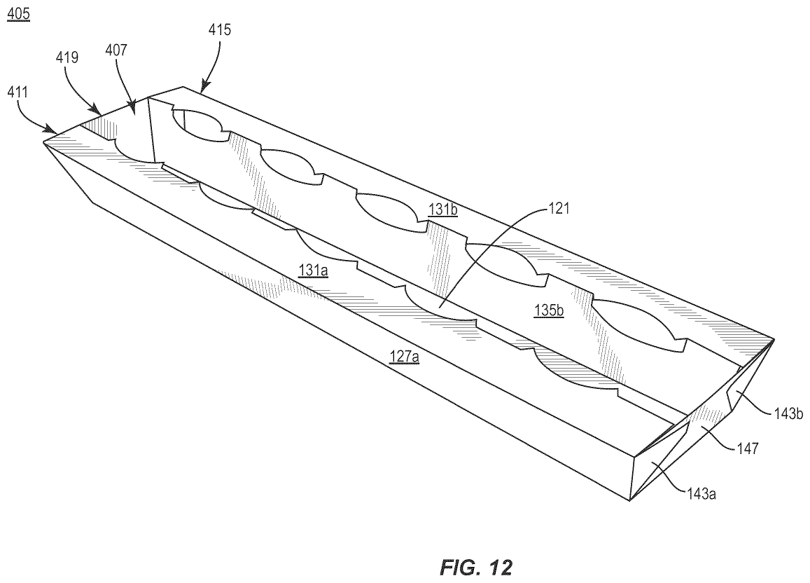

Turning to FIGS. 11 and 12, the tray 405 can be formed from the blank 403 in a manner generally similar to that described above with respect to the formation of the trays 105, 205, 305 from the blanks 103, 203, 303 with similar advantages and functionality.

The aforementioned arrangement of the tray 405 provides the front portion 411 and the back portion 415 thereof.

It will be understood that, prior to, during, and/or following formation of the tray 405 from the blank 403, one or more articles A can be at least partially received in the interior 407 of the tray 405 and at least partially engaged with the respective article retention features 169a, 169b. In some embodiments, the tray 405 can be provided with one or more of the articles A as a package.

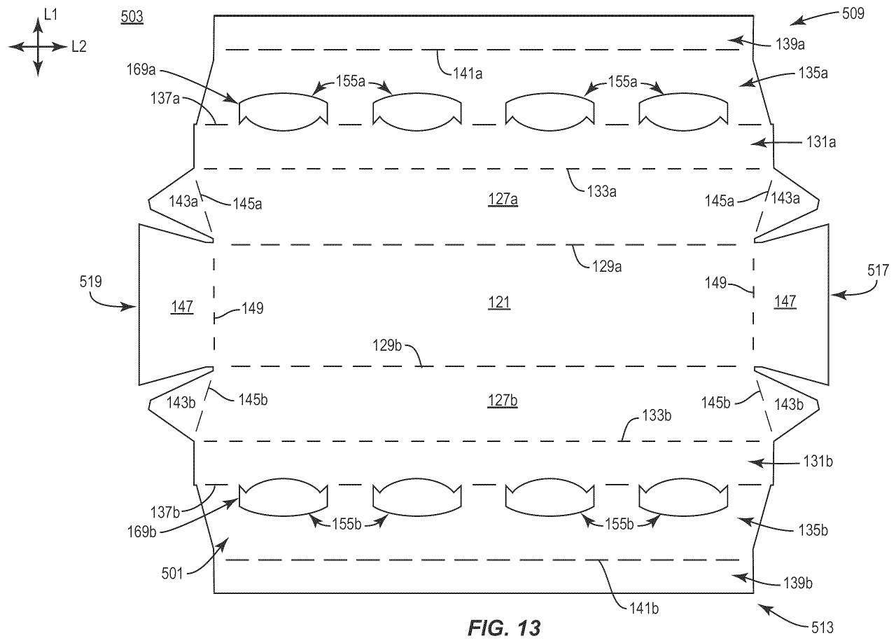

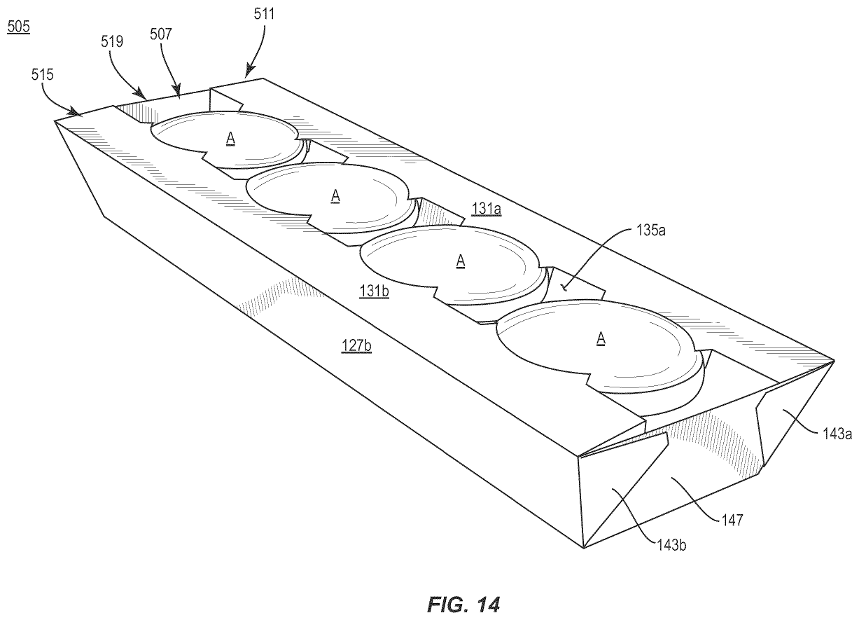

Turning to FIG. 13, the exterior surface 501 of a blank 503 for forming a tray 505 according to a fifth exemplary embodiment of the disclosure is shown. The blank 503 and tray 505 formed therefrom can have one or more features that are the same or similar to those described above with respect to the blanks 103, 203, 303, 403 and trays 105, 205, 305, 405 formed therefrom, and like or similar features are designated with like or similar reference numerals.

The blank 503 and tray 505 formed therefrom can be generally similar to the blank 403 and tray 405 formed therefrom, but can have a longer dimension in the lateral direction L2, for example, so as to accommodate a larger number of articles A.

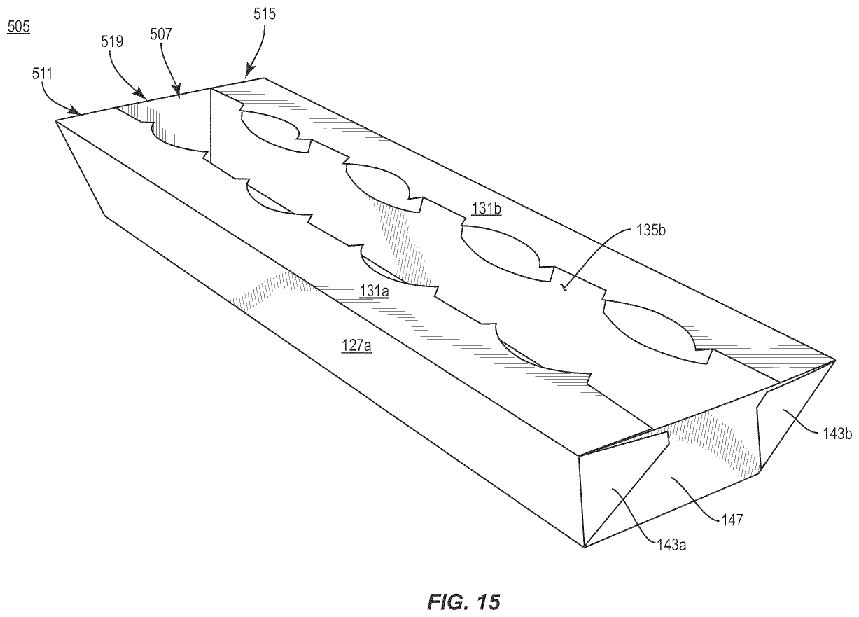

Turning to FIGS. 14 and 15, the tray 505 can be formed from the blank 503 in a manner generally similar to that described above with respect to the formation of the trays 105, 205, 305, 403 from the blanks 103, 203, 303, 403 with similar advantages and functionality.

The aforementioned arrangement of the tray 505 provides the front portion 511 and the back portion 515 thereof.

It will be understood that, prior to, during, and/or following formation of the tray 505 from the blank 503, one or more articles A can be at least partially received in the interior 507 of the tray 505 for at least partial engagement with the respective container retention features 169a, 169b. In some embodiments, the tray 505 can be provided with one or more of the articles A as a package.

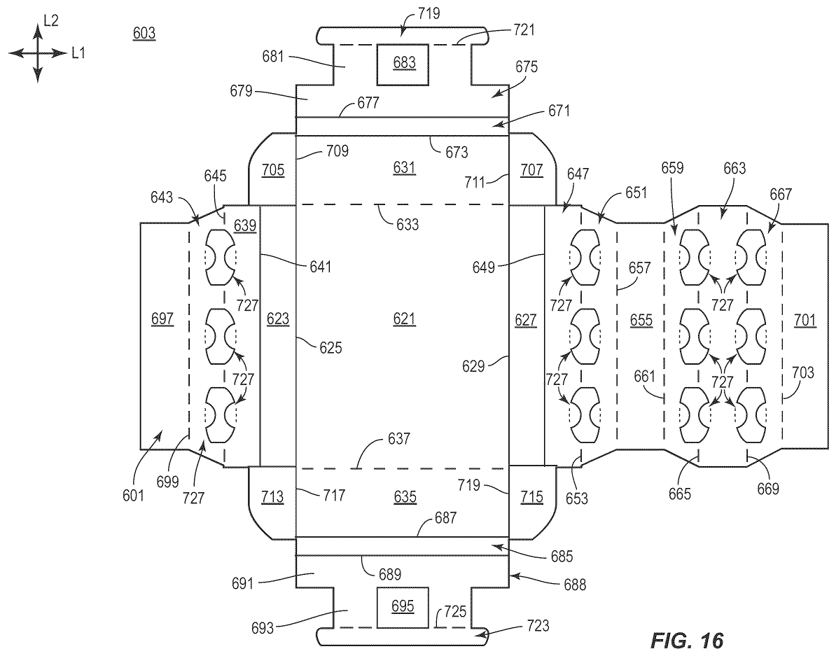

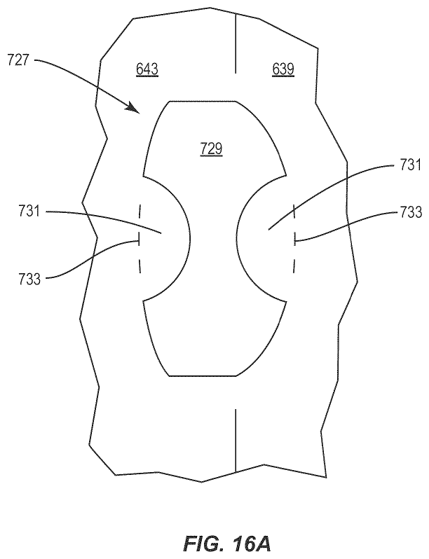

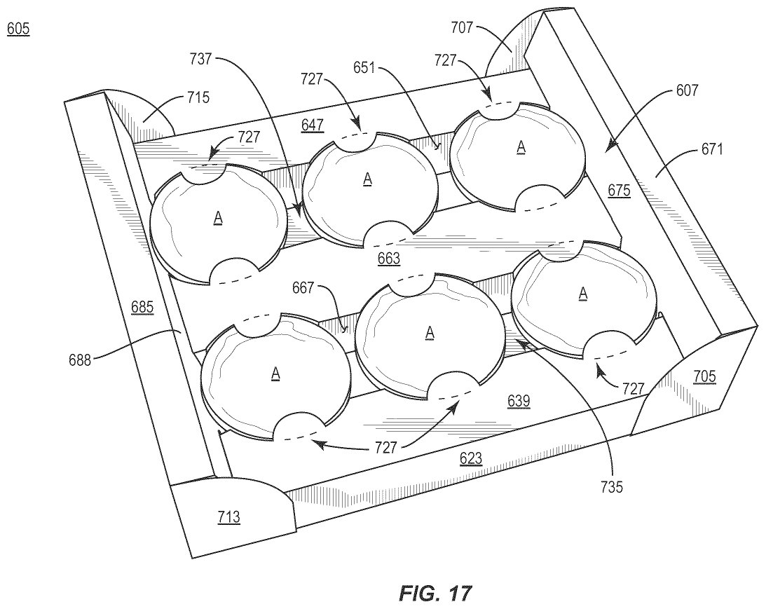

Turning to FIG. 16, the exterior surface 601 of a blank 603 for forming a tray 605 (FIG. 17) according to a sixth exemplary embodiment of the disclosure is shown. The blank 603 and tray 605 formed therefrom can have one or more features that are the same or similar to those described above with respect to the blanks 103, 203, 303, 403, 503 and trays 105, 205, 305, 405, 505 formed therefrom, and like or similar features are designated with like or similar reference numerals.

As shown, the blank 603 and tray 605 formed therefrom can include a plurality of panels that includes a bottom panel 621, a first side panel 623 foldably connected to the bottom panel 621 at a lateral fold line 625, a second side panel 627 foldably connected to the bottom panel 621 at a lateral fold line 629, a first outer end panel 631 foldably connected to the bottom panel 621 at a longitudinal fold line 633, and a second outer end panel 635 foldably connected to the bottom panel 621 at a longitudinal fold line 637.

A first top retainer panel 639 can be foldably connected to the first side panel 623 at a lateral fold line 641, and a first inner retainer panel 643 can be foldably connected to the top retainer panel 639 at a lateral fold line 645.

Similarly, a second top retainer panel 647 can be foldably connected to the second side panel 627 at a lateral fold line 649, and a second inner retainer panel 651 can be foldably connected to the top retainer panel 647 at a lateral fold line 653.

A bottom attachment panel 655 can be foldably connected to the inner retainer panel 651 at a lateral fold line 657, to which a side retainer panel 659 is foldably connected at a lateral fold line 661. A central or third top retainer panel 663 can be foldably connected to the side retainer panel 659 at a lateral fold line 665, and another side retainer panel 667 can be foldably connected to the top retainer panel 663 at a lateral fold line 669. In this regard, the top retainer panels 639, 647, 663 can be spaced apart from one another.

An end top panel 671 can be foldably connected to the first outer end panel 631 at a longitudinal fold line 673, and an inner end panel 675 can be foldably connected to the end top panel 671 at a lateral fold line 677. The inner end panel 675, as shown, can include a base portion 679 foldably connected to the panel 671 at the fold line 677, and a distal portion 681 extending therefrom. The distal portion 681 of the panel 675 can have a width in the longitudinal direction L1 that is generally less than that of the base portion 679 thereof, and can be at least partially interrupted by an opening 683 in the inner end panel 675.

Similarly, an end top panel 685 can be foldably connected to the second outer end panel 635 at a longitudinal fold line 687, and an inner end panel 688 can be foldably connected to the end top panel 685 at a lateral fold line 689. The inner end panel 687, as shown, can include a base portion 691 foldably connected to the panel 685 at the fold line 689, and a distal portion 693 extending therefrom. The distal portion 693 of the panel 685 can have a width in the longitudinal direction L1 that is generally less than that of the base portion 691 thereof, and can be at least partially interrupted by an opening 695 in the inner end panel 687.

The blank 603 and tray 605 formed therefrom can also include a plurality of end flaps foldably connected to a respective panel of the plurality of panels.

As shown, a bottom attachment end flap 697 can be foldably connected to the inner retainer panel 643 at a lateral fold line 699 and a bottom attachment end flap 701 can be foldably connected to the side retainer panel 667 at a lateral fold line 703. In some embodiments, one or both of the bottom attachment end flaps 697, 701 can be panels of the plurality of panels of the blank 603 and tray 605 formed therefrom.

Corner end flaps 705, 707 can be foldably connected to the outer end panel 631 respective lateral fold lines 709, 711, and can be separable from the respective panels 623, 639, 627, 647 at respective cuts.

Similarly, corner end flaps 713, 715 can be foldably connected to the outer end panel 635 respective lateral fold lines 717, 719, and can be separable from the respective panels 623, 639, 627, 647 at respective cuts.

An attachment end flap 719 can be foldably connected to the distal portion 681 of the inner end panel 675 at a longitudinal fold line 721 interrupted by the opening 683, and an attachment end flap 723 can be foldably connected to the distal portion 693 of the inner end panel 687 at a longitudinal fold line 725 interrupted by the opening 695.

The blank 603 and tray 605 formed therefrom can also include article retention features 727 for at least partially retaining one or more articles A in the interior 607 of the tray 605 formed from the blank 603.

With additional reference to FIG. 16A, a plurality of laterally-spaced article retention openings 729 can be at least partially defined in respective portions of the panels 639, 643, 647, 651, 659, 663, 667, e.g., so as to interrupt the respective fold lines 645, 653, 665, 669.

Each article retention opening 729, as shown, can be arranged such that a respective pair of longitudinally opposed article retention tabs 731 can be positioned extending therein and foldably connected to a respective panel at a respective curved fold line 733.

As described further herein, the edges of the respective panels that at least partially define the respective article retention openings 729, as well as the respective article retention tabs 731, can at least partially define the respective article retention features 727 when the tray 605 is formed from the blank 603.

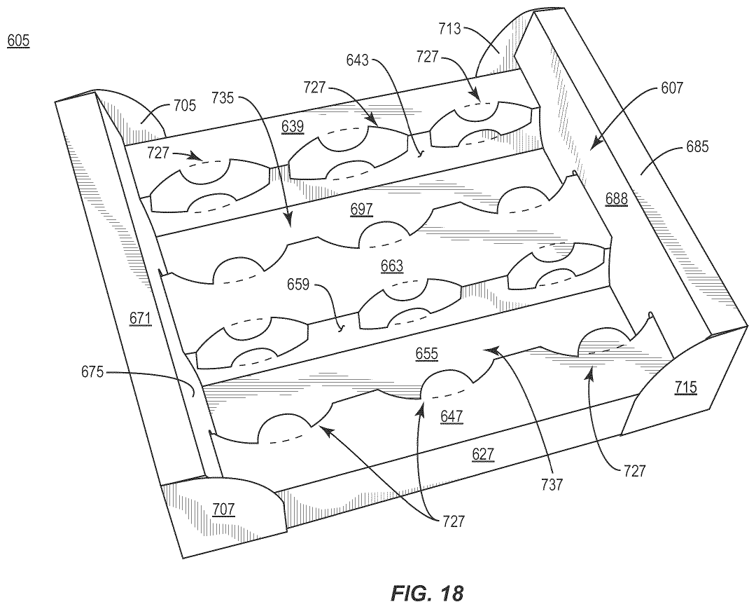

With additional reference to FIGS. 17 and 18, the blank 603 can be inverted such that the exterior surface 601 is positioned facing on a supporting surface, e.g., a conveyor, bedplate, table, other support etc., and such that an interior surface thereof, e.g., planarly opposite the exterior surface 601, can be positioned facing upwardly.

The top retainer panel 647 can be folded at the fold line 649 into at least partial face-to-face contact with respective portions of the side panel 627 and such that the inner retainer panel 651 is carried into at least partial face-to-face contact with respective portions of the side panel 627 and/or bottom panel 621, such that the bottom attachment panel 655 is carried into at least partial face-to-face contact with a respective portion of the bottom panel 621, such that the side retainer panel 659 is carried into at least partial face-to-face contact with a respective portion of the bottom panel 621, such that the top retainer panel 663 is carried into at least partial face-to-face contact with a respective portion of the bottom panel 621, such that the side retainer panel 667 is carried into at least partial face-to-face contact with a respective portion of the bottom panel 621, and such that the bottom attachment end flap 701 is carried into at least partial face-to-face contact with a respective portion of the bottom panel 621.

Similarly, the top retainer panel 639 can be folded at the fold line 641 into at least partial face-to-face contact with respective portions of the side panel 623 and such that the inner retainer panel 643 is carried into at least partial face-to-face contact with respective portions of the side panel 623 and/or bottom panel 621, and such that the bottom attachment end flap 697 is carried into at least partial face-to-face contact with a respective portion of the bottom attachment end flap 701.

The top retainer panel 663 can be positioned in generally spaced and planar relation with the bottom panel 621 such that the side retainer panels 659, 667 can be positioned extending downwardly therefrom toward the panels 621/655 and end flaps 697, 701. Such arrangement can be facilitated by at least partial folding of the side retainer panels 659, 667 relative to the top retainer panel 667 at the respective fold lines 665, 669.

Similarly, the top retainer panel 647 can be positioned in generally spaced and planar relation with the bottom panel 621 such that the inner retainer panel 651 and the side panel 627 can be positioned extending downwardly therefrom toward the panels 621/655 and end flaps 697, 701. Such arrangement can be facilitated by at least partial folding of the side retainer panel 647 and side panel 627 relative to the top retainer panel 651 at the respective fold lines 649, 629.

The top retainer panel 639 can be positioned in generally spaced and planar relation with the bottom panel 621 such that the inner retainer panel 643 and side panel 623 can be positioned extending downwardly therefrom toward the panel 621 and end flaps 697, 701. Such arrangement can be facilitated by at least partial folding of the inner retainer panel 643 and side panel 623 relative to the top retainer panel 639 at the respective fold lines 645, 641.

In such an arrangement, the end top panel 671 can be folded at the fold line 673 and the inner end panel 675 can be folded at the fold line 677 such that the attachment end flap 719 extending therefrom can be positioned in at least partial face-to-face contact with the bottom panel 621.

The outer side panel 631 can then be folded upwardly at the fold line 633 into a generally upright position such that the end top panel 671 extends generally perpendicularly therefrom toward the interior 607 of the tray 605, e.g., so as to be in generally spaced and planar relation with the bottom panel 621, and such that the inner end panel 675 extends generally perpendicularly downwardly into the interior 607 of the tray 605, with the attachment end flap 719 folded at the fold line 721 to extend generally perpendicularly away therefrom.

In such an arrangement, the opening 683 in the inner end panel 685 can be positioned to at least partially receive a portion of one or more of the top retention panel 663, the side retention panel 659, and the side retention panel 667.

Thereafter, the corner end flaps 705, 707 can be folded at the respective fold lines 709, 711 into at least partial face-to-face contact with respective portions of the side panels 623, 627.

Similarly, the end top panel 685 can be folded at the fold line 687 and the inner end panel 689 can be folded at the fold line 687 toward the interior 607 of the tray 605 such that the attachment end flap 723 can be positioned in at least partial face-to-face contact with the bottom panel 621.

The outer side panel 635 can then be folded upwardly at the fold line 637 into a generally upright position such that the end top panel 685 extends generally perpendicularly therefrom toward the interior 607 of the tray 605, e.g., in generally spaced and planar relation the bottom panel 621, and such that the inner end panel 689 extends generally perpendicularly downwardly into the interior 607 of the tray 605, with the attachment end flap 723 folded at the fold line 725 to extend generally perpendicularly away therefrom.

In such an arrangement, the opening 695 in the inner end panel 689 can be positioned to at least partially receive a portion of one or more of the top retention panel 663, the side retention panel 659, and the side retention panel 667.

Thereafter, the corner end flaps 713, 715 can be folded at the respective fold lines 717, 719 into at least partial face-to-face contact with respective portions of the side panels 623, 627.

The aforementioned arrangement of the tray 605 provides the interior 607 with an interior space 735 at least partially defined between respective portions of the bottom panel 621, the retention panels 643, 667, and the end panels 631, 635 and an interior space 737 at least partially defined between respective portions of the bottom panel 621, the retention panels 651, 659, and the end panels 631, 635.

It will be understood that, prior to, during, and/or following formation of the tray 605 from the blank 603, one or more articles A can be at least partially received in the interior 607 of the tray 605 and at least partially engaged by a respective article retention feature 727.

In such arrangements, a respective article A, e.g., a food product, can be at least partially received in the respective interior space 735, 737 in the interior 607 of the tray 605 and can be at least partially received through a respective article retention opening 729 and at least partially overlapped by a respective article retention tab 731. In some embodiments, the respective article retention tab 731 can move relative to an adjacent panel at a respective fold line 731. In some embodiments, the respective article A can be at least partially compressed between the respective article retention tab 731 and the bottom panel 621. In other embodiments, the engagement of the respective article A with the respective article retention features 727 can at least partially suspend the respective article A above the respective panel 621, 655, end flap 697/701 in the interior 607 of the tray 605.

In this regard, the tray 605 is provided with article retention features for at least partially retaining respective articles A in the interior 607 thereof. Such retention of the article(s) A can advantageously maintain articles A during incidental movement, for example, during shipping, storage, placement in a retail location, transport from a retail location to a customer's home or other desired location, etc.

In some embodiments, the article retention features of the tray 605 can provide an at least partially recessed engagement of a respective article A, e.g., such that at least a portion of a respective article A is at least partially surrounded by respective panels, end flaps, and/or other features thereof, such that the respective article A is at least partially protected from an outside environment thereby, e.g., so as to avoid damaging contact, so as to transmit external forces away from the respective article A, etc. In some embodiments, the tray 605 can be provided with one or more articles A as a package.

It will be understood that the blanks and trays described herein can have a different configuration and/or arrangement without departing from the disclosure.

In general, the blanks described herein may be constructed from paperboard having a caliper so that it is heavier and more rigid than ordinary paper. The blanks can also be constructed of other materials, such as cardboard, sheet plastics or any other material having properties suitable for enabling the container to function at least generally as described above. The blanks can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

As an example, a tear line can include: a slit that extends partially into the material along the desired line of weakness, and/or a series of spaced apart slits that extend partially into and/or completely through the material along the desired line of weakness, or various combinations of these features. As a more specific example, one type of tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

In accordance with the exemplary embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the container embodiments. The term “glue” is intended to encompass all manner of adhesives commonly used to secure container panels in place, and is not intended to exclude heat, chemical, or frequency bonding techniques.

The foregoing description of the disclosure illustrates and describes various embodiments. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments. Additionally, the disclosure shows and describes only selected embodiments, but various other combinations, modifications, and environments are within the scope of the disclosure as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A tray for holding a plurality of articles, the tray comprising:
a plurality of panels extending at least partially around an interior of the tray, the plurality of panels comprising at least one bottom panel, at least one side panel, and at least one retainer panel;
a plurality of end flaps foldably connected to a respective panel of the plurality of panels; and
a plurality of article retention features at least partially defined in the at least one retainer panel, the article retention features for at least partially receiving and at least partially engaging the plurality of articles to maintain a position of the plurality of articles in the interior of the tray.

2. The tray of claim 1, wherein at least one article retention feature of the plurality of article retention features comprises an article retention opening at least partially formed in the at least one retainer panel.

3. The tray of claim 2, wherein the at least one article retention feature is at least partially formed by a plurality of edges of the at least one retainer panel, the plurality of edges comprising a generally curved article retention edge intersecting a pair of oblique article retention edges, the plurality of edges protruding from the at least one retainer panel.

4. The tray of claim 3, wherein the article retention opening is at least partially formed in the at least one side panel.

5. The tray of claim 4, wherein the at least one side panel is an at least one inner side panel, and the plurality of panels further comprises at least one outer side panel.

6. The tray of claim 5, wherein the at least one retainer panel extends from the at least one outer side panel to the at least one inner side panel.

7. The tray of claim 1, wherein the tray comprises a front portion, a back portion, and a central portion, the at least one article retention opening is at least partially formed in the at least one side panel, the at least one side panel is at least one front side panel, the at least one bottom panel is a front bottom panel, the central portion comprises a central panel, and the at least one article retention opening is at least partially formed in the at least one central panel.

8. The tray of claim 7, wherein a front interior space is formed in the interior of the tray for at least partially receiving respective articles of the plurality of articles in the front portion of the tray and a back interior space is formed in the interior of the tray for at least partially receiving respective articles of the plurality of articles in the back portion of the tray.

9. The tray of claim 2, wherein the at least one retainer panel is a first top retainer panel, the plurality of panels further comprises a second top retainer panel and a third top retainer panel.

10. The tray of claim 9, wherein the plurality of article retention features comprises at least one article retention opening at least partially formed in the first top retainer panel, at least one article retention opening at least partially formed in the second top retainer panel, and at least one article retention opening at least partially formed in the third top retainer panel.

11. The tray of claim 10, wherein the plurality of article retention features comprises at least one article retention tab positioned extending into at least one of the article retention opening at least partially formed in the first top retainer panel, the at least one article retention opening at least partially formed in the second top retainer panel, or the at least one article retention opening at least partially formed in the third top retainer panel.

12. The tray of claim 11, wherein the first top retainer panel, the second top retainer panel, and the third top retainer panel are spaced apart from one another.

13. A blank for forming a tray for holding a plurality of articles, the blank comprising:
a plurality of panels for extending at least partially around an interior of the tray formed from the blank, the plurality of panels comprising at least one bottom panel, at least one side panel, and at least one retainer panel;
a plurality of end flaps foldably connected to a respective panel of the plurality of panels; and
a plurality of article retention features at least partially defined in the at least one retainer panel, the article retention features for at least partially receiving and at least partially engaging the plurality of articles to maintain a position of the plurality of articles in the interior of the tray formed from the blank.

14. The blank of claim 13, wherein at least one article retention feature of the plurality of article retention features comprises an article retention opening at least partially formed in the at least one retainer panel.

15. The blank of claim 14, wherein the at least one article retention feature is at least partially formed by a plurality of edges of the at least one retainer panel, the plurality of edges comprising a generally curved article retention edge intersecting a pair of oblique article retention edges, the plurality of edges protruding from the at least one retainer panel.

16. The blank of claim 15, wherein the article retention opening is at least partially formed in the at least one side panel.

17. The blank of claim 16, wherein the at least one side panel is an at least one inner side panel, and the plurality of panels further comprises at least one outer side panel.

18. The blank of claim 17, wherein the at least one retainer panel extends from the at least one outer side panel to the at least one inner side panel.

19. The blank of claim 13, wherein the blank comprises a front portion, a back portion, and a central portion, the at least one article retention opening is at least partially formed in the at least one side panel, the at least one side panel is at least one front side panel, the at least one bottom panel is a front bottom panel, the central portion comprises a central panel, and the at least one article retention opening is at least partially formed in the at least one central panel.

20. The blank of claim 14, wherein the at least one retainer panel is a first top retainer panel, the plurality of panels further comprises a second top retainer panel and a third top retainer panel.

21. The blank of claim 20, wherein the plurality of article retention features comprises at least one article retention opening at least partially formed in the first top retainer panel, at least one article retention opening at least partially formed in the second top retainer panel, and at least one article retention opening at least partially formed in the third top retainer panel.

22. The blank of claim 21, wherein the plurality of article retention features comprises at least one article retention tab positioned extending into at least one of the article retention opening at least partially formed in the first top retainer panel, the at least one article retention opening at least partially formed in the second top retainer panel, or the at least one article retention opening at least partially formed in the third top retainer panel.

23. The blank of claim 22, wherein the first top retainer panel, the second top retainer panel, and the third top retainer panel are spaced apart from one another.

24. A method of forming a tray for holding a plurality of articles, the method comprising:
obtaining a blank, the blank comprising a plurality of panels comprising at least one bottom panel, at least one side panel, and at least one retainer panel, a plurality of end flaps foldably connected to a respective panel of the plurality of panels, and a plurality of article retention features at least partially defined in the at least one retainer panel;
positioning the plurality of panels extending at least partially around an interior of the tray formed from the blank; and
positioning the article retention features for at least partially receiving and at least partially engaging the plurality of articles to maintain a position of the plurality of articles in the interior of the tray.

25. The method of claim 24, wherein at least one article retention feature of the plurality of article retention features comprises an article retention opening at least partially formed in the at least one retainer panel.

26. The method of claim 25, wherein the at least one article retention feature is at least partially formed by a plurality of edges of the at least one retainer panel, the plurality of edges comprising a generally curved article retention edge intersecting a pair of oblique article retention edges, the plurality of edges protruding from the at least one retainer panel.

27. The method of claim 26, wherein the article retention opening is at least partially formed in the at least one side panel.

28. The method of claim 27, wherein the at least one side panel is an at least one inner side panel, and the plurality of panels further comprises at least one outer side panel.

29. The method of claim 28, wherein the at least one retainer panel extends from the at least one outer side panel to the at least one inner side panel.

30. The method of claim 24, wherein the blank comprises a front portion, a back portion, and a central portion, the at least one article retention opening is at least partially formed in the at least one side panel, the at least one side panel is at least one front side panel, the at least one bottom panel is a front bottom panel, the central portion comprises a central panel, and the at least one article retention opening is at least partially formed in the at least one central panel.

31. The method of claim 30, further comprising forming a front interior space in the interior of the tray for at least partially receiving respective articles of the plurality of articles in the front portion of the tray, and forming a back interior space in the interior of the tray for at least partially receiving respective articles of the plurality of articles in the back portion of the tray.

32. The method of claim 25, wherein the at least one retainer panel is a first top retainer panel, the plurality of panels further comprises a second top retainer panel and a third top retainer panel.

33. The method of claim 32, wherein the plurality of article retention features comprises at least one article retention opening at least partially formed in the first top retainer panel, at least one article retention opening at least partially formed in the second top retainer panel, and at least one article retention opening at least partially formed in the third top retainer panel.

34. The method of claim 33, wherein the plurality of article retention features comprises at least one article retention tab positioned extending into at least one of the article retention opening at least partially formed in the first top retainer panel, the at least one article retention opening at least partially formed in the second top retainer panel, or the at least one article retention opening at least partially formed in the third top retainer panel.

35. The method of claim 34, wherein the first top retainer panel, the second top retainer panel, and the third top retainer panel are spaced apart from one another.
